(19) United States
(12) Patent Application Publication
(10) Pub. No.: US 2004/0252095 A1
(43) Pub. Date: Dec. 16, 2004

(54) Liquid crystal display module and the fabrication method of the same

(76) Inventor: San-Hong Chiang, Taipei (TW)

Correspondence Address: BIRCH STEWART KOLASCH & BIRCH, PO BOX 747, FALLS CHURCH, VA, 22040-0747, US

(21) Appl. No.: 10/459,459

(22) Filed: Jun. 12, 2003

(51) Int. Cl. G09G 3/36

(52) U.S. Cl. 345/102

(57) ABSTRACT

A liquid crystal display (LCD) module and the fabrication method of the same, which includes a display unit, a first driving circuit, a second driving circuit and a backlight module. The first and second driving circuits comprise of vertical scan driving circuits, horizontal data driving circuits and control circuits. Using the integrated driving circuit arrangement, the best structural arrangement for LCD module is accomplished. The structural conversion of the LCD module also improves the efficiency of the production procedures and using the overall production process to reduce cost.

### BACKGROUND OF THE INVENTION

1. Field of Invention

The present invention relates to a Liquid Crystal Display (LCD) module and the fabrication method of the same, especially an integrated circuits LCD module and the fabrication method of the same.

2. Related Art

A Liquid Crystal Display (LCD) is a major player in the display panel industry. Due to the decreasing price for LCD's and following the trend of electronics getting lighter, thinner, shorter and smaller, the competition for LCD manufacturing is fiercer than ever. Therefore, improving the production method, lowering cost and designing an even lighter, thinner display structure is the major development goal for all LCD manufacturers.

During TFT-LCD (thin-film transistor LCD) production, technologies from different industries are combined, such as a semiconductor, chemical, and optical. There are three major production steps: array production, cell production, and module production. Array production process glass substrates with semiconductor production procedures, such as deposition, exposure, development, and etching, to form a large number of TFT-LCD's on the substrate. During cell production, the array processed substrate and another substrate are both processed with polyamide. The substrates are then press-combined, using precision instruments. After adding on seal, cutting to the determined panel size, pouring in the liquid crystal and then assembling elements such as the polarizer the LCD display panel is finished. Finally, the module production completes the LCD module which assembles the display unit with exterior parts such as the circuit board, and backlight module to form the LCD module.

Usually, the current LCD module manufacturers out-source the array and cell productions to LCD panel factories. The finished LCD panels are sent to the LCD module factories to finish the production. Since LCD panels need to follow multiple standards in order to make the exterior parts fit during the final assembly at the LCD module factories, it is difficult to improve the production procedures and the assembly process.

### SUMMARY OF THE INVENTION

To improve the current technology, the invention provides a liquid crystal display (LCD) module and the fabrication method of the same that combines the LCD module's driving circuit and control circuit to decrease the overall volume of the module. As the structure of the LCD changes, combining the LCD production makes it more efficient during the manufacturing of LCD modules.

The LCD module of the invention receives display data from an external apparatus and generates corresponding images on the display screen. The module includes a display unit, a first driving circuit, a second driving circuit, and a backlight module. The display unit is a rectangular plane that is comprised of: a plurality of scan line that are perpendicular to a plurality of data; a plurality of pixels located inside of squares formed by the forth mentioned perpendicular scan line and data line , which are lined up to create a displaying screen; a plurality of transistors located at the intersection points of the scan line and the data line that are used to drive the described pixels. The first driving circuit is located on the vertical side of the display unit, which includes the vertical scan driving circuit that receives the display signal and uses the scan line to scan the pixels to drive their transistors. The second driving circuit is located on the horizontal side of the display unit and includes a horizontal data driving circuit that is synchronized with the forth-mentioned scanning. The driving circuit receives a display signal to determine display voltage of the selected pixels. The control circuit can be combined with either the first driving circuit or the second driving circuit to receive the display data, and generate a display signal. The backlight module is fixed on the other side of the display screen on the display unit and sometimes provides light, as backlighting source.

The invention provides a more economically beneficial production method for a LCD module, which combines the manufacturing process of driving circuit and control circuit into production process of the display unit. After adding the backlight module and completing the assembly process, the production is finished. The summary of the production process is described as follows. First, provide a display unit, which is composed of a plurality of scan line, data line, pixels, and transistors. The pixels are located inside of the blocks formed by the scan line column and data line; they are lined up to form a display screen. The transistors are located at the intersection points of the scan line and data line; they are used to drive the described pixels. Then, provide a first driving circuit that is located at the vertical side of the display unit and connected to the scan lines. The first driving circuit includes a vertical scan driving circuit and a control circuit; it receives the display signal and scans the pixels via the scan line to drive the transistors of the selected pixels. The control circuit receives the display data and generates the display data accordingly. A second driving circuit is provided, which is located at the horizontal side of the display unit and connected to the data line. It includes a horizontal data driving circuit, which is synchronized with the scanning of the vertical scan driving circuit; it receives the display signal from the control circuit and determines display voltage of the selected pixels. Finally, fix the backlight module onto the other side of the display screen, on the display unit. The LCD module of the invention and its fabrication method improves the structure of LCD modules and production methods. Also, combining the control circuit with the second driving circuit can achieve similar affects.

The invention also comprises of a front frame that is a little larger than the display unit to fasten the display unit and the backlight module while disposing the display area of the display unit. There is also a back cover, which is fixed to the other side of the display screen and connected to the front frame.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given in the illustration below only, and thus are not limitative of the present invention:

FIG. 1 illustrates the circuit placement of the liquid crystal display module.

FIG. 2 illustrates the disassembled front cover and the display unit.

FIG. 3 illustrates the disassembled back cover and the display unit.

FIG. 4 illustrates the disassembled front and back cover and the display unit.

FIG. 5 illustrates the enlarged connective joints for the front and back covers.

FIG. 6 illustrates the production process flow diagram.

### DETAILED DESCRIPTION OF THE INVENTION

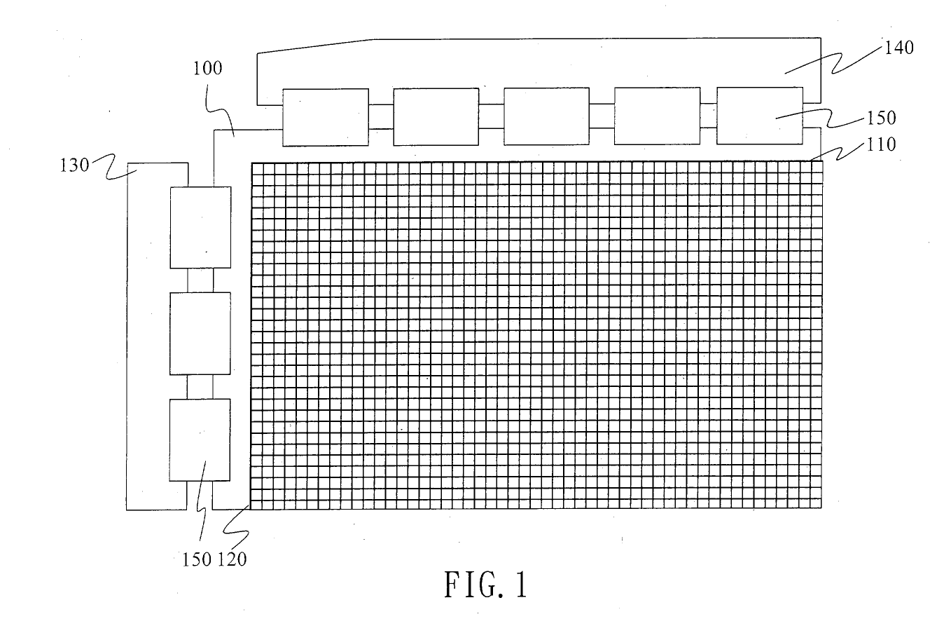

Please refer to FIG. 1, which illustrates the circuit placement of the LCD module. It comprises of a display unit 100, a first driving circuit 130, a second driving circuit 140, and backlight module (not shown in the picture). Display unit 100 is composed of a matrix of pixels, transistors connected to each pixel, and a plurality of data lines, 110 and scan lines 120 that are perpendicular. The pixels are located inside of the blocks formed by the described data lines 110 and scan lines 120; they are arranged to form a display screen. The transistors are located at the intersecting points of the data lines 110 and scan lines 120, used to drive the described pixels. The first driving circuit 130 includes a vertical scan driving circuit and a control circuit. It is located at the vertical side of the display unit 100 via a plurality of flexible circuit boards 150 and connected to the scan lines electrically. As the vertical scan driving circuit receives a display signal, it uses the scan line to scan the pixels and drives the transistors of the selected pixels. The control circuit receives the display data from the external apparatus and produces a display signal. A second driving circuit 140 is located at the horizontal side of the display unit 100 via a plurality of flexible circuit boards 150 and electrically connected to the data lines. It includes a horizontal data driving circuit, which is synchronized with a vertical scanning driving circuit, and receives a display signal to determine displaying voltage of the selected pixels.

The invention combines the production process of the driving circuit and control circuit to the circuit board before connecting to the display unit. Within the second driving circuit, the control circuit can also be combined with the horizontal data driving circuit. The control circuit also includes a control chip, which combines the timing controller, TCON, and an auto-detecting scaler. The combined control circuit with the first driving circuit or second driving circuit can be manufactured using the 1.6 mm printing circuit board.

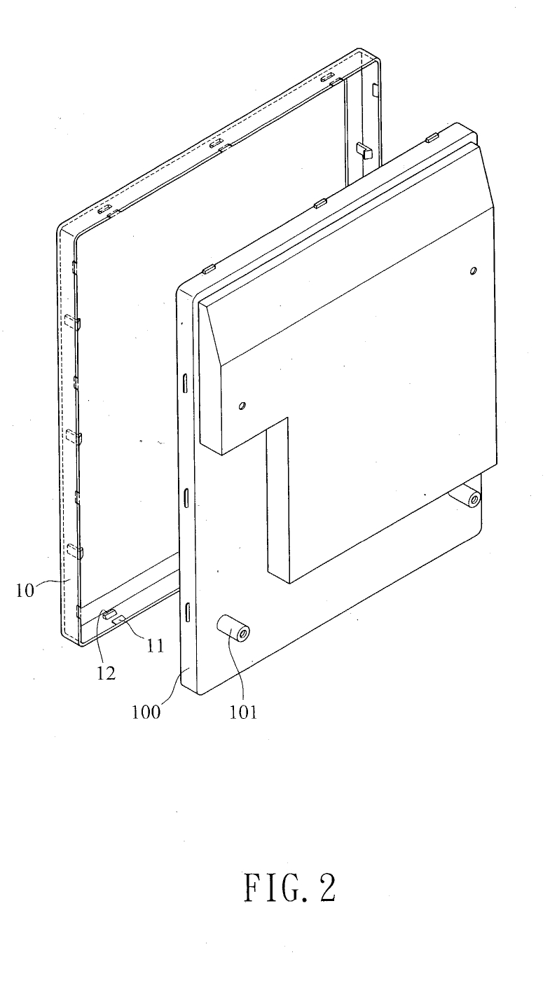

Please refer to FIG. 2 for the structural illustration of the invention with the disassembled front frame and display unit. The invention also improves the structure by using a front frame 10 to fasten the display unit 100 and backlight module, while disposing the display screen of the display unit 100. During production, the front frame 10 is assembled with the display unit 100 (following the direction of the arrow) first. It covers all sides of the display unit 100 and the edges of the display area and uses a plurality of fixed elements 12 on the inside of the front frame 10 to fasten the display unit 100.

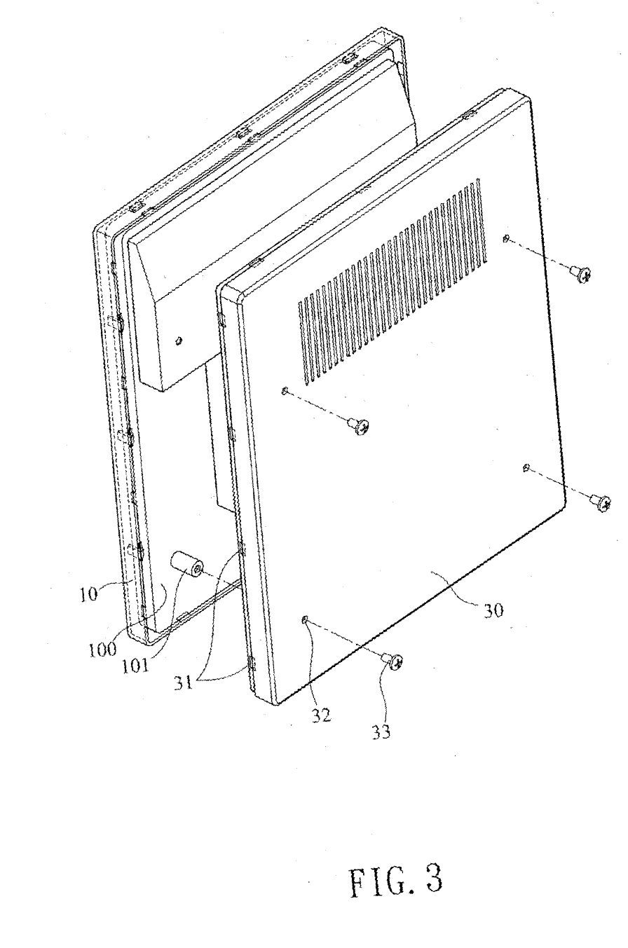

Please refer to FIG. 3 for the structural illustration of the invention with the back cover disassembled. After assembling the front frame 10, the back cover 30 is added onto the other side of the display screen on the display unit. The back cover 30 has a plurality of connecting holes 20 and a slot 31 and a display unit 100 has a plurality of coupled sections 101 corresponding to the connecting holes 32. A plurality of connecting element 33 passes through connecting holes 32 to fasten onto coupled sections 101 and secure the back cover 30 to the display unit 100. The front frame 10 is also coupled with the back cover 30.

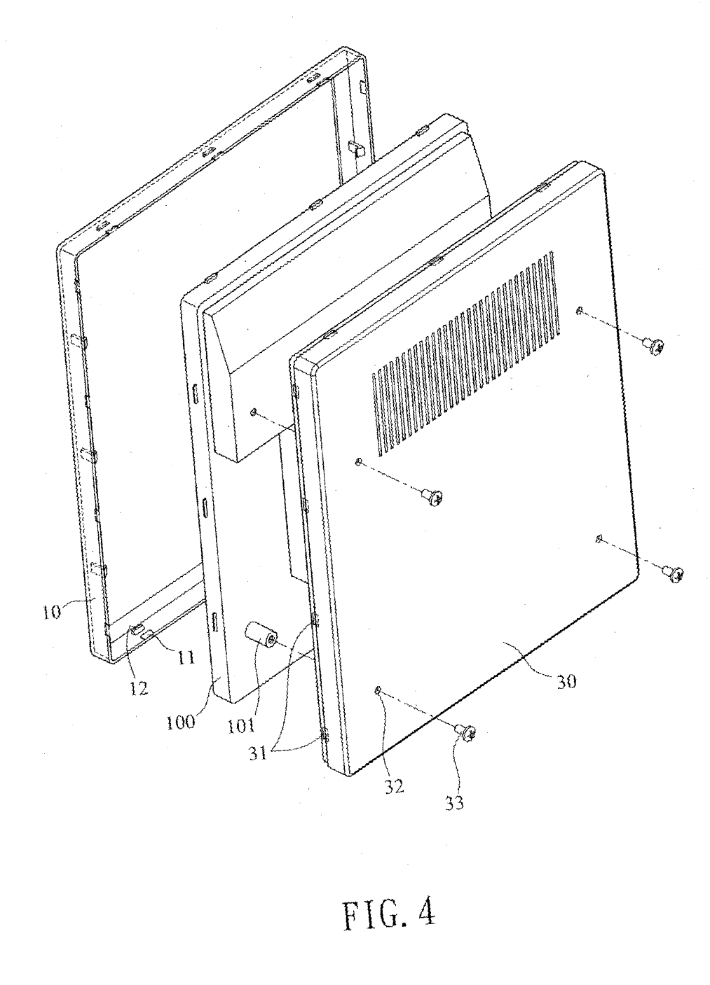

Please refer to FIG. 4 for the structural illustration of the invention with both the front frame and back cover disassembled. The front frame 10 and back cover 30 can be assembled at the same time, so they are coupled with each other.

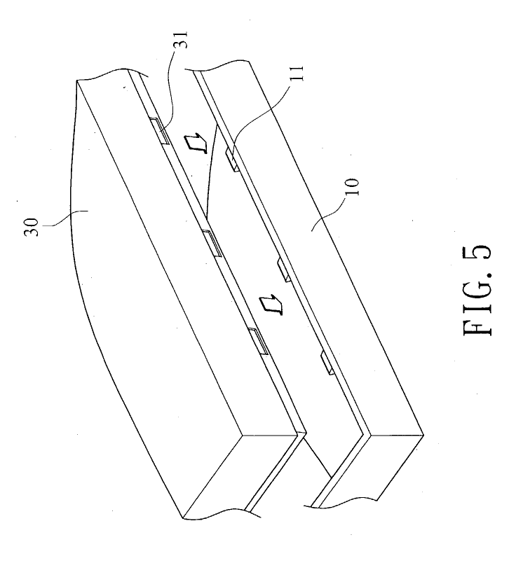

Please refer to FIG. 5 for the enlarged illustration of the connection between the front frame and the back cover; the slot 31 of the back cover 30 is fixed in place by a hook 11 in the inside edge of the front frame 10.

Also, the production process of the LCD module of this invention combines the production of the driving circuit and the control circuit in the production of the display unit, and finally completes the back light module and finishes assembling procedures.

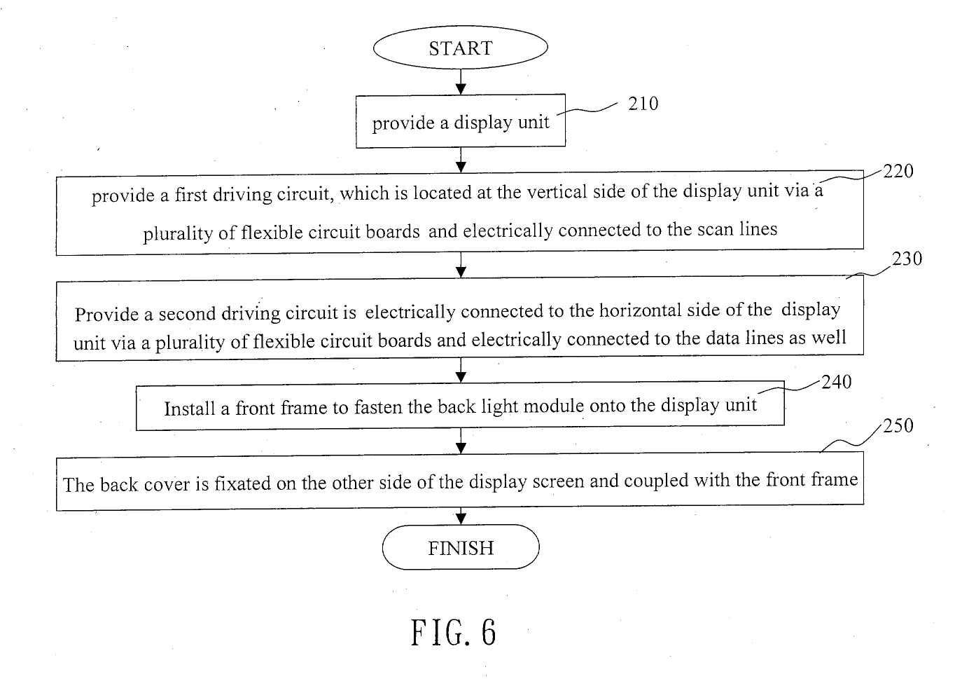

Please refer to FIG. 6, which illustrates the flow diagram of the production method introduced by this invention. First, provide a display unit (step 210), which comprises of a matrix of pixels, transistors connected to each pixel, a plurality of perpendicular data lines and scan lines. The pixels are located inside of the squares formed by the described data lines and scan lines to form a display screen. The transistors are located at the intersecting points of the data lines and scan lines to drive the described pixels. Then provide a first driving circuit, which is located at the vertical side of the display unit via a plurality of flexible circuit boards and electrically connected to the scan lines (step 220). The vertical scan driving circuit receives a display signal and scans the pixels using the described scan lines and drive the transistors of the selected pixels. Provide a second driving circuit is electrically connected to the horizontal side of the display unit via a plurality of flexible circuit boards and electrically connected to the data lines as well (step 230). It is synchronized with the scanning of the vertical scan driving circuit, and receives a display signal to determine the display voltage of the selected pixels. Install a front frame to fasten the back light module onto the display unit (step 240), so the back light module is set up on the other side of the display screen on the display unit. The front frame needs to expose the display screen of the display unit. The back cover is fixated on the other side of the display screen and coupled with the front frame (step 250). The control circuit is combined with either the first driving circuit or second driving circuit to receive the display data from the external apparatus, and then generates a display signal to transmit to the driving circuit.

Reading the invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A Liquid Crystal Display module, that receives display data and generates corresponding image picture on the display panel, comprises of:
a display unit, which is a rectangular plane that is comprised of:
a plurality of scan lines;
a plurality of data lines that are perpendicular to the scan lines;
a plurality of pixels that are located inside of the squares formed by the scan lines and data lines, arranged in matrix format to form a display screen; and
a plurality of transistors that are located on the intersecting points of the data lines and scan lines to drive the pixels;
a first driving circuit that is located on the vertical side of the display unit and connected to the scan lines, comprises of:
a control circuit that receives the display data and generates a display signal; and
a vertical scan driving circuit that receives the display signal from the scan lines to scan the pixels and drives the transistors of the selected pixels;
a second driving circuit that is located on the horizontal side of the display unit and connected to the data lines, comprises of a horizontal data driving circuit that is synchronized with the scanning of the vertical scan driving circuit, and receives the display signal to determine the display voltage of the selected pixels; and
a backlight module that is fixed onto the other side of the display screen on the display unit and provides backlight source.

2. The LCD module of claim 1 wherein the control circuit comprises of a control chip combining timing controller, TCON, and auto-detecting scaler.

3. The LCD module of claim 1 further comprising a front frame, which is a rectangular frame that is slightly larger than the display unit, is used to fasten the display unit and backlight module and exposes the display screen on the display unit.

4. The LCD module of claim 3 wherein the fixing elements are set inside the front frame to fasten the display unit and the backlight module.

5. The LCD module of claim 3 further comprising a back cover, which has a plurality of connecting holes that are corresponding to the coupling section located on the other side of the display screen on the display unit, the connecting element passes through the connecting holes to fasten onto the coupling section and secure the back cover to the display unit.

6. The LCD module of claim 1 further comprising a back cover that is located on the other side of the display screen on the display unit to cover the display unit and backlight module.

7. The LCD module of claim 6 wherein the back cover has the connecting holes corresponding to a plurality of coupling section located on the other side of the display screen on the display unit, and is connected to the coupling section via a plurality of connecting element through the connecting holes.

8. A Liquid Crystal Display module that receives display data to generate corresponding image picture on the display panel, comprises of.
a display unit, which is a rectangular comprises of:
a plurality of scan lines;
a plurality of data lines that are perpendicular to the scan lines;
a plurality of pixels that are located inside of the squares formed by the scan lines and data lines, arranged in matrix format to form a display screen; and
a plurality of transistors that are located on the intersecting points of the data lines and scan lines to drive the pixels;
a first driving circuit that is located on the vertical side of the display unit and connected to the scan lines, comprises of a vertical scan driving circuit that receives the display signal from the scan lines and scans the pixels and drives the transistors of the selected pixels;
a second driving circuit that is located on the horizontal side of the display unit and connected to the data lines, comprises of:
a control circuit that receives the display data and generates a display signal; and
a horizontal data driving circuit that is synchronized with the scanning of the vertical scan driving circuit, and receives the display signal to determine the display voltage of the selected pixels; and
a backlight module that is fixed onto the other side of the display screen on the display unit and provides backlight source.

9. The LCD module of claim 8 wherein the control circuit comprises of a control chip combining timing controller, TCON, and auto-detecting scaler.

10. The LCD module of claim 8 further comprising a front frame, which is a rectangular frame that is slightly larger than the display unit, is used to fasten the display unit and backlight module and exposes the display screen on the display unit.

11. The LCD module of claim 10 further comprising a plurality of fixing elements are set inside the front frame to fasten the display unit and the backlight module.

12. The LCD module of claim 10 further comprising a back cover, which has a plurality of connecting holes that are corresponding to a plurality of coupling section located on the other side of the display screen on the display unit, a plurality of connecting element through the connecting holes to fasten onto the coupling section and secure the back cover to the display unit.

13. The LCD module of claim 8 further comprising a back cover that is located on the other side of the display screen on the display unit to cover the display unit and backlight module.

14. The LCD module of claim 13 wherein the back cover has a plurality of connecting holes corresponding to a plurality of coupling section located on the other side of the display screen on the display unit, and is connected to the coupling section via a plurality of connecting element through the connecting holes.

15. A fabrication method of the LCD module, with steps comprise of:
providing a display unit, which is a rectangular that is comprised of:
a plurality of scan lines;
a plurality of data lines that are perpendicular to the scan lines;
a plurality of pixels that are located inside of the squares formed by the scan lines and data lines, arranged in a matrix format to form a display screen; and
a plurality of transistors that are located on the intersecting points of the data lines and scan lines to drive the pixels;
providing a first driving circuit that is located on the vertical side of the display unit and connected to the scan lines, comprises of:
a control circuit that receives the display data and generates a display signal; and
a vertical scan driving circuit that receives the display signal from the scan lines and scans the pixels and drives the transistors of the selected pixels;
providing a second driving circuit that is located on the horizontal side of the display unit and connected to the data lines, which is comprised of a horizontal data driving circuit that is synchronized with the scanning of the vertical scan driving circuit, and receives the display signal to determine the display voltage of the selected pixels; and
fixing a backlight module onto the other side of the display screen on the display unit.

16. The fabrication method of the LCD module of claim 15 wherein the control circuit comprises of a control chip combining timing controller, TCON, and auto-detecting scaler.

17. The fabrication method of LCD module of claim 15 wherein the backlight module and the backlight module fasten onto a front frame.

18. The fabrication method of LCD module of claim 15 further comprising the step of fixating a back cover onto the other side of the display screen on the display unit.

19. A fabrication method of the LCD module, with steps comprise of:
providing a display unit, which is a rectangular plane, comprises of:
a plurality of scan lines;
a plurality of data lines that are perpendicular to the scan lines;
a plurality of pixels that are located inside of the squares formed by the scan lines and data lines, arranged in a matrix format to form a display screen; and
a plurality of transistors that are located on the intersecting points of the data lines and scan lines to drive the pixels;
providing a first driving circuit that is located on the vertical side of the display unit and connected to the scan lines that is comprised of a vertical scan driving circuit that receives the display signal from the scan lines and scans the pixels and drives the transistors of the selected pixels;
providing a second driving circuit that is located on the horizontal side of the display unit and connected to the data lines, comprises of:
a control circuit that receives the display data and generates a display signal; and
a horizontal data driving circuit that is synchronized with the scanning of the vertical scan driving circuit, and receives the display signal to determine the display voltage of the selected pixels; and
fixing a backlight module that onto the other side of the display screen.

20. The fabrication method of LCD module of claim 19 wherein the control circuit comprises of a control chip combining timing controller, TCON, and auto-detecting scaler.

21. The fabrication method of LCD module of claim 19 wherein the backlight module and the backlight module fasten onto a front frame.

22. The fabrication method of LCD module of claim 19 further comprising the step of fixating a back cover onto the other side of the display screen on display unit.
